(19) United States
(12) Patent Application Publication
(10) Pub. No.: US 2024/0416465 A1
(43) Pub. Date: Dec. 19, 2024

(54) ALUMINUM ALLOY BRAZING SHEET AND METHOD FOR PRODUCING SAME

(71) Applicant: UACJ Corporation, Tokyo (JP)

(72) Inventors: Taichi Suzuki, Tokyo (JP); Tomoki Yamayoshi, Tokyo (JP); Wataru Nakagawa, Tokyo (JP); Makoto Ando, Tokyo (JP)

(73) Assignee: UACJ Corporation, Tokyo (JP)

(21) Appl. No.: 18/704,303

(22) PCT Filed: Oct. 11, 2022
(86) PCT No.: PCT/JP2022/037876

§ 371 Date: Apr. 24, 2024

(30) Foreign Application Priority Data
Nov. 4, 2021 (JP) 2021-180239

(51) Int. Cl. B23K 35/02; B23K 35/28; C22C 21/02; C22C 21/08; C22F 1/04; C22F 1/043; C22F 1/05

(52) U.S. Cl. CPC B23K 35/0238; B23K 35/288; C22C 21/02; C22C 21/08; C22F 1/04; C22F 1/043; C22F 1/05

(57) ABSTRACT

An aluminum alloy brazing sheet has a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of Mn content/Si content of 0.10 or more and less than 1.00, a value of Mg content+Si content of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities.

### TECHNICAL FIELD

The present invention relates to an aluminum alloy brazing sheet used for an aluminum alloy heat exchanger and a method for producing the same.

### BACKGROUND ART

Aluminum alloys, which have light weight and high thermal conductivity, are frequently used for heat exchangers for automobiles such as evaporators and condensers. The heat exchangers comprise a tube where coolant flows and fins for exchanging heat between the coolant and air existing outside of the tube, and the tube and the fins are jointed by brazing. Joint of the tube and the fins is frequently performed by brazing using a fluorine-based flux in a furnace under an inert gas atmosphere.

In recent years, in order to cool batteries mounted on electric vehicles, products in which a coolant flow path is formed by laminating press-formed plates and jointing by brazing have been put into practical use. In this case, a brazing material is arranged at the laminated part and brazing is frequently performed using a fluorine-based flux in a furnace under an inert gas atmosphere similar to the above case. The tube materials and the plate materials subjected to brazing as described above are comprehensively called brazing sheets.

The fluorine-based flux is used in the flux brazing described above. This flux is melted during brazing heating to promote flow of a melted brazing material by breaking an oxide film on the brazing material surface. However, the fluorine-based flux forms an inactive compound by reacting with magnesium comprised in aluminum alloys to deteriorate brazing properties and thus a Mg concentration is generally limited in the aluminum alloys subjected to the flux brazing in many cases. From these reasons, generally, Al—Mn-based alloys not including Mg such as a 3003 alloy are frequently used for the core material of the brazing sheets.

On the other hand, the Al—Mn-based core material has limitation when high strength after brazing is intended to be achieved. Therefore, techniques for achieving high strength after brazing by using Al—Mg-based or Al—Mg—Si-based alloys in which Mg is added in a range where the flux brazing properties do not deteriorate have been developed.

### CITATION LIST

### Patent Literature

Patent Literature 1: WO 2002/049798
Patent Literature 2: WO 2005/010223

### SUMMARY OF INVENTION

### Technical Problem

According to the methods described in Patent Literature 1 and Patent Literature 2, restricting the upper limits of elements such as Mg, Si, and Cu added to the core material of the brazing sheet may allow the brazing properties and the strength after brazing, in particular yield strength after natural aging to be improved.

However, with respect to these methods, further higher strength is difficult to achieve. Higher contents of Si, Mg, and the like in order to achieve further higher strength may cause the solidus temperature of the core material to be low and thus melting of members may occur during brazing.

Therefore, an object of the present invention is to provide an aluminum alloy brazing sheet that can prevent defects caused by melting the members during brazing and can provide higher strength of the members after brazing.

### Solution to Problem

As a result of intensive studies for solving the above problems, the inventors of the present invention have found that the Si content, the Mn content, and the Mg content of the aluminum alloy brazing sheet are set to predetermined ranges, the relations among these contents are further set to predetermined ranges, and an ingot for the core material in which the Si content, the Mn content, and the Mg content are in the predetermined ranges and the relations among these contents are in the predetermined ranges is subjected to homogenization treatment at a predetermined temperature during a process for producing the aluminum alloy brazing sheet, whereby the solidus temperature of the core material is not excessively low and the strength is higher than strength of conventional aluminum alloy brazing sheets after artificial aging or room temperature aging is applied at specific retention temperature and retention time after brazing heating. Thus, the inventors of the present invention have accomplished the present invention.

That is, the present invention (1) provides an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 150±5° C. for 60±5 minutes, a value of tensile strength in terms of the core material alone of the aluminum alloy brazing sheet after the heating and high temperature retention test is 220 MPa or more.

The present invention (2) provides an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 170±5° C. for 40±5 minutes, a value of tensile strength in terms of the core material alone of the aluminum alloy brazing sheet after the heating and high temperature retention test is 220 MPa or more.

The present invention (3) provides an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 190±5° C. for 5±2 minutes, a value of tensile strength in terms of the core material alone of the aluminum alloy brazing sheet after the heating and high temperature retention test is 220 MPa or more.

The present invention (4) provides an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 210±5° C. for 5±2 minutes, a value of tensile strength in terms of the core material alone of the aluminum alloy brazing sheet after the heating and high temperature retention test is 220 MPa or more.

The present invention (5) provides an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and low temperature retention test in which a temperature is raised to a heating retention temperature at an average temperature rising rate of 50° C./min to 150° C./min, retained for 3±2 minutes at 600±10° C., subsequently dropped from the heating retention temperature to a low retention temperature at an average temperature falling rate of 20° C./min to 120° C./min, and thereafter retained for 336±5 hours at 25±5° C., a value of tensile strength in terms of the core material alone of the aluminum alloy brazing sheet after the heating and low temperature retention test is 220 MPa or more.

The present invention (6) provides an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to a low retention temperature at an average temperature falling rate of 20° C./min to 120° C./min, and thereafter retained at 150±5° C. for 60±5 minutes, a Vickers hardness of a core material part cross-section of the aluminum alloy brazing sheet after the heating and high temperature retention test is 66 or more.

The present invention (7) provides an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to a low temperature retention temperature at an average temperature falling rate of 20° C./min to 120° C./min, and thereafter retained at 170±5° C. for 40±5 minutes, a Vickers hardness of a core material part cross-section of the aluminum alloy brazing sheet after the heating and high temperature retention test is 66 or more.

The present invention (8) provides an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to a low retention temperature at an average temperature falling rate of 20° C./min to 120° C./min, and thereafter retained at 190±5° C. for 5±2 minutes, a Vickers hardness of a core material part cross-section of the aluminum alloy brazing sheet after the heating and high temperature retention test is 66 or more.

The present invention (9) provides an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to a low retention temperature at an average temperature falling rate of 20° C./min to 120° C./min, and thereafter retained at 210±5° C. for 5±2 minutes, a Vickers hardness of a core material part cross-section of the aluminum alloy brazing sheet after the heating and high temperature retention test is 66 or more.

The present invention (10) provides an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and low temperature retention test in which a temperature is raised to a heating retention temperature at an average temperature rising rate of 50° C./min to 150° C./min, retained for 3±2 minutes at 600±10° C., subsequently dropped from the heating retention temperature to a low retention temperature at an average temperature falling rate of 20° C./min to 120° C./min, and thereafter retained for 336±5 hours at 25±5° C., a Vickers hardness of a core material part cross-section of the aluminum alloy brazing sheet after the heating and low temperature retention test is 66 or more.

The present invention (11) provides the aluminum alloy brazing sheet according to any one of (1) to (10), comprising:
a three-layer material comprising an intermediate layer and a brazing material clad on one side surface of the core material in order of brazing material/intermediate material/core material, wherein
the brazing material is formed of an aluminum alloy comprising 5.00 mass % to 13.00 mass % of Si, and
the intermediate layer is formed of an aluminum alloy having a Mg content of 0.20 mass % or less.

The present invention (12) provides the aluminum alloy brazing sheet according to any one of (1) to (10) comprising:
a four-layer material comprising an intermediate layer and a brazing material cladded on one side surface of the core material and a sacrificial anode material cladded on the other side surface of the core material in order of brazing material/intermediate material/core material/sacrificial anode material, wherein
the brazing material is formed of an aluminum alloy comprising 5.00 mass % to 13.00 mass % of Si,
the intermediate layer is formed of an aluminum alloy having a Mg content of 0.20 mass % or less, and
the sacrificial anode material is formed of an aluminum alloy comprising 0.50 mass % to 3.00 mass % of Zn.

The present invention (13) provides the aluminum alloy brazing sheet according to any one of (1) to (10) comprising:
a five-layer material comprising an intermediate layer and a brazing material cladded on one side surface of the core material and an intermediate layer and a brazing material cladded on the other side surface of the core material in order of brazing material/intermediate material/core material/intermediate layer/brazing material, wherein
the brazing material is formed of an aluminum alloy comprising 5.00 mass % to 13.00 mass % of Si, and
the intermediate layer is formed of an aluminum alloy having a Mg content of 0.20 mass % or less.

The present invention (14) provides a method for producing an aluminum alloy brazing sheet including a multilayer for an aluminum alloy heat exchanger, the method comprising:
a casting step of casting an ingot for a core material formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities;
a homogenization treatment step of heating the ingot for a core material at 400° C. to 540° C.;
a hot rolling step of stacking a hot-rolled ingot for a clad material onto the ingot for a core material to perform hot rolling; and
a cold rolling step.

The present invention (15) provides the method for producing an aluminum alloy brazing sheet according to (14), wherein final annealing treatment of heating at 350° C. or more is performed after performing the cold rolling step.

The present invention (16) provides the method for producing an aluminum alloy brazing sheet according to (14), wherein final annealing treatment of heating at less than 350° C. is performed after performing the cold rolling step.

The present invention (17) provides the method for producing an aluminum alloy brazing sheet according to (14), wherein intermediate annealing treatment of heating at 350° C. or more is performed in the course of the cold rolling step.

The present invention (18) provides an aluminum alloy brazing sheet including a multilayer for an aluminum alloy heat exchanger obtained by performing
a casting step of casting an ingot for a core material formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities;
a homogenization treatment step of heating the ingot for a core material at 400° C. to 540° C.;
a hot rolling step of stacking an ingot for a hot-rolled clad material onto the ingot for a core material to perform hot rolling;
a cold rolling step; and
a final annealing treatment step of heating at 350° C. or more after performing the cold rolling step.

The present invention (19) provides an aluminum alloy brazing sheet including a multilayer for an aluminum alloy heat exchanger obtained by performing
a casting step of casting an ingot for a core material formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities;
a homogenization treatment step of heating the ingot for a core material at 400° C. to 540° C.;
a hot rolling step of stacking an ingot for a hot-rolled clad material onto the ingot for a core material to perform hot rolling;
a cold rolling step; and
a final annealing treatment step of heating at less than 350° C. after performing the cold rolling step.

The present invention (20) provides an aluminum alloy brazing sheet including a multilayer for an aluminum alloy heat exchanger obtained by performing
a casting step of casting an ingot for a core material formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities;
a homogenization treatment step of heating the ingot for a core material at 400° C. to 540° C.;
a hot rolling step of stacking an ingot for a hot-rolled clad material onto the ingot for a core material to perform hot rolling;
a cold rolling step; and
an intermediate annealing treatment step of heating at 350° C. or more in the course of the cold rolling step.

### Advantageous Effect of Invention

According to the present invention, it is possible to provide an aluminum alloy brazing sheet that can prevent defects caused by melting the members during brazing and can provide higher strength of the members after brazing.

### DESCRIPTION OF EMBODIMENTS

An aluminum alloy brazing sheet according to a first embodiment of the present invention is an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 50° C./min to 150° C./min, retained at 600±3° C. for 5±3 minutes, subsequently dropped from the heating retention temperature to a low retention temperature at an average temperature falling rate of 20° C./min to 120° C./min, and thereafter retained at 150±5° C. for 60±5 minutes, a value of tensile strength in terms of the core material alone of the aluminum alloy brazing sheet after the heating and high temperature retention test is 220 Mpa or more.

An aluminum alloy brazing sheet according to a second embodiment of the present invention is an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 170±5° C. for 40±5 minutes, a value of tensile strength in terms of the core material alone of the aluminum alloy brazing sheet after the heating and high temperature retention test is 220 Mpa or more.

An aluminum alloy brazing sheet according to a third embodiment of the present invention is an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 190±5° C. for 5±2 minutes, a value of tensile strength in terms of the core material alone of the aluminum alloy brazing sheet after the heating and high temperature retention test is 220 Mpa or more.

An aluminum alloy brazing sheet according to a fourth embodiment of the present invention is an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 210±5° C. for 5±2 minutes, a value of tensile strength in terms of the core material alone of the aluminum alloy brazing sheet after the heating and high temperature retention test is 220 Mpa or more.

An aluminum alloy brazing sheet according to a fifth embodiment of the present invention is an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and low temperature retention test in which a temperature is raised to a heating retention temperature at an average temperature rising rate of 50° C./min to 150° C./min, retained at 600±10° C. for 3±2 minutes, subsequently dropped from the heating retention temperature to a low retention temperature at an average temperature falling rate of 20° C./min to 120° C./min, and thereafter retained at 25±5° C. for 336±5 hours, a value of tensile strength in terms of the core material alone of the aluminum alloy brazing sheet after the heating and low temperature retention test is 220 MPa or more.

An aluminum alloy brazing sheet according to a sixth embodiment of the present invention is an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to a low retention temperature at an average temperature falling rate of 20° C./min to 120° C./min, and thereafter retained at 150±5° C. for 60±5 minutes, a Vickers hardness of a core material part cross-section of the aluminum alloy brazing sheet after the heating and high temperature retention test is 66 or more.

An aluminum alloy brazing sheet according to a seventh embodiment of the present invention is an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to a low retention temperature at an average temperature falling rate of 20° C./min to 120° C./min, and thereafter retained at 170±5° C. for 40±5 minutes, a Vickers hardness of a core material part cross-section of the aluminum alloy brazing sheet after the heating and high temperature retention test is 66 or more.

An aluminum alloy brazing sheet according to an eighth embodiment of the present invention is an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to a low retention temperature at an average temperature falling rate of 20° C./min to 120° C./min, and thereafter retained at 190±5° C. for 5±2 minutes, a Vickers hardness of a core material part cross-section of the aluminum alloy brazing sheet after the heating and high temperature retention test is 66 or more.

An aluminum alloy brazing sheet according to a ninth embodiment of the present invention is an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to a low retention temperature at an average temperature falling rate of 20° C./min to 120° C./min, and thereafter retained at 210±5° C. for 5±2 minutes, a Vickers hardness of a core material part cross-section of the aluminum alloy brazing sheet after the heating and high temperature retention test is 66 or more.

An aluminum alloy brazing sheet according to a tenth embodiment of the present invention is an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, wherein
in a heating and low temperature retention test in which a temperature is raised to a heating retention temperature at an average temperature rising rate of 50° C./min to 150° C./min, retained at 600±10° C. for 3±2 minutes, subsequently dropped from the heating retention temperature to a low retention temperature at an average temperature falling rate of 20° C./min to 120° C./min, and thereafter retained at 25±5° C. for 336±5 hours, a Vickers hardness of a core material part cross-section of the aluminum alloy brazing sheet after the heating and low temperature retention test is 66 or more.

In the present invention, the description “XX mass % or less” is description including 0.00 mass %. In other words, “XX mass % or less” means “0.00 mass % to XX mass %”.

Namely, the aluminum alloy brazing sheet of the present invention is an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, in which the following any one of (a1) to (a4) is satisfied:
(a1) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 150±5° C. for 60±5 minutes, a value of tensile strength in terms of the core material alone of the aluminum alloy brazing sheet after the heating and high temperature retention test is 220 MPa or more,
(a2) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 170±5° C. for 40±5 minutes, a value of tensile strength in terms of the core material alone of the aluminum alloy brazing sheet after the heating and high temperature retention test is 220 MPa or more,
(a3) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 190±5° C. for 5±2 minutes, a value of tensile strength in terms of the core material alone of the aluminum alloy brazing sheet after the heating and high temperature retention test is 220 MPa or more, and
(a4) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 210±5° C. for 5±2 minutes, a value of tensile strength in terms of the core material alone of the aluminum alloy brazing sheet after the heating and high temperature retention test is 220 MPa or more, or
an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, in which
in a heating and low temperature retention test in which a temperature is raised to a heating retention temperature at an average temperature rising rate of 50° C./min to 150° C./min, retained for 3±2 minutes at 600±10° C., subsequently dropped from the heating retention temperature to a low retention temperature at an average temperature falling rate of 20° C./min to 120° C./min, and thereafter retained for 336±5 hours at 25±5° C., a value of tensile strength in terms of the core material alone of the aluminum alloy brazing sheet after the heating and low temperature retention test is 220 MPa or more, or
an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, in which the following any one of (b1) to (b4) is satisfied:
(b1) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 150±5° C. for 60±5 minutes, a Vickers hardness of a core material part cross-section of the aluminum alloy brazing sheet after the heating and high temperature retention test is 66 or more,
(b2) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 170±5° C. for 40±5 minutes, a Vickers hardness of a core material part cross-section of the aluminum alloy brazing sheet after the heating and high temperature retention test is 66 or more,
(b3) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 190±5° C. for 5±2 minutes, a Vickers hardness of a core material part cross-section of the aluminum alloy brazing sheet after the heating and high temperature retention test is 66 or more, and
(b4) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 210±5° C. for 5±2 minutes, a Vickers hardness of a core material part cross-section of the aluminum alloy brazing sheet after the heating and high temperature retention test is 66 or more, or
an aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, in which
in a heating and low temperature retention test in which a temperature is raised to a heating retention temperature at an average temperature rising rate of 50° C./min to 150° C./min, retained for 3±2 minutes at 600±10° C., subsequently dropped from the heating retention temperature to a low retention temperature at an average temperature falling rate of 20° C./min to 120° C./min, and thereafter retained for 336±5 hours at 25±5° C., a Vickers hardness of a core material part cross-section of the aluminum alloy brazing sheet after the heating and low temperature retention test is 66 or more.

Hereinafter, common points in the aluminum alloy brazing sheets of the first embodiment to the tenth embodiment of the present invention are descried as the aluminum alloy brazing sheet of the present invention by collectively referring to the aluminum alloy brazing sheets of the first embodiment to the tenth embodiment of the present invention.

The aluminum alloy brazing sheet of the present invention is a brazing sheet brazed by forming into the shape of constituent members of the heat exchanger and brazing heating in the production of the aluminum alloy heat exchanger, that is, an aluminum alloy brazing sheet for the aluminum alloy heat exchanger.

The aluminum alloy brazing sheet of the present invention is an aluminum alloy brazing sheet including a multilayer in which one or more clad materials are cladded on the core material. The aluminum alloy brazing sheet of to the present invention comprises one or more brazing materials. In the aluminum alloy brazing sheet of the present invention, the clad material other than the core material and at least one brazing material is not particularly limited as long as the aluminum alloy brazing sheet of the present invention comprises the core material and at least one brazing material.

As the aluminum alloy brazing sheet of the present invention, the followings are included.
(1) An aluminum alloy brazing sheet comprising a three-layer material comprising a core material, and an intermediate layer and a brazing material cladded on one side surface of the core material in order of brazing material/intermediate material/core material,
(2) An aluminum alloy brazing sheet comprising a four-layer material comprising a core material, an intermediate layer and a brazing material cladded on one side surface of the core material, and a sacrificial anode material cladded on the other side surface of the core material in order of brazing material/intermediate material/core material/sacrificial anode material, and
(3) An aluminum alloy brazing sheet comprising a five-layer material comprising a core material, an intermediate layer and a brazing material cladded on one side surface of the core material, and an intermediate layer and a brazing material cladded on the other side surface of the core material in order of brazing material/intermediate material/core material/intermediate material/brazing material.

The core material according to the aluminum alloy brazing sheet of the present invention is formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities.

The core material according to the aluminum alloy brazing sheet of the present invention comprises Si. Si forms solid solution in an Al (aluminum) mother phase during brazing heating and thereafter a fine Mg₂Si precipitate is formed between the solid solution and Mg solid solution similarly formed during room temperature aging. Consequently, Si has an action for improving strength by being precipitated and dispersed in the mother phase. The Si content in the core material is 0.20 mass % to 1.00 mass % and preferably 0.40 mass % to 0.90 mass %. The Si content in the core material within the above range allows a strength improvement effect to be obtained and defects such as partially melting a member during brazing heating caused by lowering the solidus temperature due to excessive formation of solid solution of Si in the mother phase to be less likely to occur. On the other hand, a Si content in the core material of less than the above range causes the above strength improvement effect not to be obtained, whereas a Si content in the core material of more than the above range causes the solidus temperature to be lowered by forming excessive solid solution of Si in the mother phase and thus defects such as partial melting of a member during brazing heating to be generated.

The core material according to the aluminum alloy brazing sheet of the present invention comprises Mn. Mn is an additive element that forms an Al—Mn—Si-based intermetallic compound together with Si and acts as a dispersion strengthening or improves strength due to solid solution strengthening by forming solid solution in the aluminum mother phase. The Mn content in the core material is 0.10 mass % to 0.80 mass % and preferably 0.30 mass % to 0.80 mass %. The Mn content in the core material within the above range allows the effect of strength improvement to be obtained. On the other hand, a Mn content in the core material of less than the above range results in an insufficient strength improvement effect, whereas a Mn content of more than the above range causes excessive Al—Mn—Si-based compound to be formed and thus the strength improvement effect due to Mg₂Si precipitation during room temperature aging after brazing to be lowered.

The core material according to the aluminum alloy brazing sheet of the present invention comprises Mg. Mg forms solid solution in an Al (aluminum) mother phase during brazing heating and thereafter a fine Mg₂Si precipitate is formed between the solid solution and Si solid solution similarly formed during room temperature aging. Consequently, Mg has an action for improving strength by being precipitated and dispersed in the mother phase. The Mg content in the core material is 0.20 mass % to 1.00 mass % and preferably 0.40 mass % to 0.90 mass %. The Mg content in the core material within the above range allows the effect of strength improvement to be achieved. On the other hand, a Mg content in the core material of less than the above range results in an insufficient strength improvement effect, whereas a Mg content of more than the above range causes a compound having a high melting point to be formed by reacting Mg diffused to the brazing material surface during brazing heating with the fluorine-based flux. Consequently, the flux cannot act on the oxide film and thus joint of members by brazing becomes extremely difficult.

The contents of Si, Mn, and Mg in the core material according to the aluminum alloy brazing sheet of the present invention have the following relationship.

The value of “Mn content (mass %)/Si content (mass %)” in the core material according to the aluminum alloy brazing sheet of the present invention is 0.10 or more and less than 1.00 and preferably 0.20 or more and less than 0.90. Si and Mn form an Al—Mn—Si-based intermetallic compound and contribute to strength improvement as dispersion strengthening. The value of “Mn content (mass %)/Si content (mass %)” in the core material within the above range allows the Al—Mn—Si compound required for strength improvement to be formed. On the other hand, a value of “Mn content (mass %)/Si content (mass %)” in the core material of more than the above range results in forming an excessive Al—Mn—Si intermetallic compound and thus may cause the strength improvement effect due to Mg₂Si precipitation to deteriorate, whereas a value of less than the above range results in an insufficient strength improvement effect due to the Al—Mn—Si-based intermetallic compound.

Of the aluminum alloy brazing sheets of the present invention, the values of “Mn content (mass %)/Si content (mass %)” in the core materials according to the aluminum alloy brazing sheets of the first to fourth embodiments and the sixth to ninth embodiments of the present invention are more preferably 0.25 or more and less than 0.85 and further preferably 0.30 or more and less than 0.80. The values of “Mn content (mass %)/Si content (mass %)” in the core materials according to the aluminum alloy brazing sheets of the first to fourth embodiments and the sixth to ninth embodiments of the present invention within the above range allow the strength improvement effect in the artificial aging after brazing heating to be high.

The values of “Mn content (mass %)/Si content (mass %)” in the core materials according to the aluminum alloy brazing sheets of the fifth embodiment and the tenth embodiment of the present invention are more preferably 0.25 or more and less than 0.85 and further preferably 0.30 or more and less than 0.80. The values of “Mn content (mass %)/Si content (mass %)” in the core materials according to the aluminum alloy brazing sheets of the fifth embodiment and the tenth embodiment of the present invention within the above range allow the strength improvement effect in the room temperature aging after brazing heating to be high.

The value of “Mg content (mass %)+Si content (mass %)” in the core material according to the aluminum alloy brazing sheet of the present invention is 0.60 mass % or more and less than 1.60 mass % and preferably 0.80 mass % or more and less than 1.50 mass %. The value of “Mg content (mass %)+Si content (mass %)” in the core material within the above range allows the strength improvement effect to be obtained and defects such as partial melting of a member during brazing heating caused by lowering the solidus temperature due to excessive solid solution formation in the mother phase to be less likely to occur. On the other hand, a value of “Mg content (mass %)+Si content (mass %)” in the core material of less than the above range results in not obtaining the strength improvement effect, whereas a value of more than the above range may cause defects such as partial melting of a member during brazing heating caused by lowering the solidus temperature due to excessive solid solution formation of Mg and Si in the mother phase.

The Fe content of the core material according to the aluminum alloy brazing sheet of the present invention is 0.40 mass % or less and preferably 0.35 mass % or less. Fe is an element mixed in as impurities from bare metals and various raw materials. Although the direct effect on strength and brazing quality is small, a Fe content of more than the above range may cause coarse crystallized products to be formed during casting to deteriorate processability.

The Cu content of the core material according to the aluminum alloy brazing sheet of the present invention is 0.25 mass % or less, preferably 0.20 mass % or less and more preferably 0.05 mass % to 0.20 mass %. Cu is an additive element that forms solid solution in the matrix to improve strength. The Cu content in the core material within the above range allows the strength after brazing to be expected to be further improved. On the other hand, a Cu content in the core material of more than the above range causes the solidus temperature to be lowered due to excessive solid solution formation in the mother phase and may cause defects such as partial melting of a member during brazing heating.

The Zn content of the core material according to the aluminum alloy brazing sheet of the present invention is 2.00 mass % or less, preferably 1.50 mass % or less, and more preferably 0.05 mass % to 1.50 mass %. In the present invention, Zn mixed in the core material as impurities from the bare metals and the various raw materials can be accepted as long as Zn is within the above range. Zn may also be added in the core material in order to adjust the potential with the sacrificial anode material. However, a Zn content in the core material of more than the above range may result in not securing the difference in potential from the sacrificial anode material.

The Ti content of the core material according to the aluminum alloy brazing sheet of the present invention is 0.20 mass % or less, preferably 0.15 mass % or less, and more preferably 0.10 mass % or less. Ti is added to the aluminum alloy for the purpose of forming a fine structure during casting. Ti can be added also to the core material for the purpose of improving the corrosion resistance of the core material. On the other hand, a Ti content of the core material of more than the above range may cause giant crystallized product to be formed during casting to deteriorate hot workability. The lower limit of the Ti content in the core material is preferably 0.001 mass %.

Each of the contents of Cr and Zr in the core material according to the aluminum alloy brazing sheet of the present invention is 0.10 mass % or less, preferably 0.05 mass % or less, and more preferably 0.001 mass % to 0.05 mass %. Cr and Zr are mixed in as impurities from the bare metals and the various raw materials. In the case where Cr and Zr are actively added, the precipitation of Al—Cr-based or Al—Zr-based intermetallic compound acts to coarsen grains after brazing heating. On the other hand, a content of Cr or Zr in the core material of more than 0.10 mass % causes coarse intermetallic compounds to be easily formed and hot workability to deteriorate.

The brazing material according to the aluminum alloy brazing sheet of the present invention is formed of an aluminum alloy comprising 5.00 mass % to 13.00 mass % and preferably 6.00 mass % to 13.00 mass % of Si. The brazing material is not particularly limited as long as the brazing material can melt during brazing heating to supply a brazing substance in a clearance between the members and thereafter solidify during cooling to achieve brazing joints. Examples of the brazing material include Al—Si-based alloys including a 4343 alloy, a 4045 alloy, and a 4047 alloy.

As the brazing material, a brazing material (1) described below may be exemplified. The brazing material (1) is formed of an aluminum alloy comprising 5.00 mass % to 13.00 mass % and preferably 6.00 mass % to 13.00 mass % of Si, with the balance being Al and inevitable impurities. The brazing material (1) may further comprise one or two or more elements of 0.80 mass % or less and preferably 0.70 mass % or less of Fe, 0.30 mass % or less and preferably 0.25 mass % or less of Cu, 0.20 mass % or less and preferably 0.15 mass % or less of Mn, 0.10 mass % or less and preferably 0.05 mass % or less of Mg, 0.10 mass % or less and preferably 0.05 mass % or less of Cr, 0.20 mass % or less and preferably 0.10 mass % or less of Zn, and 0.20 mass % or less and preferably 0.10 mass % or less of Ti.

The intermediate layer according to the aluminum alloy brazing sheet of the present invention is formed of an aluminum alloy having a Mg content of 0.20 mass % or less and preferably 0.10 mass % or less. The intermediate layer is a layer inserted between the core material and the brazing material and mainly serves to prevent deterioration in the flux brazing properties caused by diffusing Mg from the core material to the surface layer of the brazing material during brazing heating. Therefore, the intermediate layer is required to have a Mg content of 0.20 mass % or less and preferably 0.10 mass % or less. The Mg content of the intermediate layer within the above range allows the total amount of Mg that diffuses from the intermediate layer and the core material to the brazing material surface layer to be reduced and thus deterioration in the brazing properties to be prevented. On the other hand, the Mg content in the intermediate layer of more than the above range may cause Mg to excessively diffuse from the intermediate layer to the brazing material surface during brazing heating and thus to deteriorate brazing properties. The intermediate layer is not particularly limited as long as the Mg content is low and Mg does not diffuse excessively from the core material to the brazing material surface layer during brazing heating. Examples of the intermediate layer include 1000 series alloys, Al—Mn-based alloys, and Al—Zn-based alloys.

As the intermediate layer, an intermediate layer (1) described below may be exemplified. The intermediate layer (1) is formed of an aluminum alloy comprising 0.20 mass % or less and preferably 0.10 mass % or less of Mg, with the balance being Al and inevitable impurities. The intermediate layer (1) may further comprise one or two or more elements of 0.60 mass % or less and preferably 0.50 mass % or less of Si, 0.70 mass % or less and preferably 0.60 mass % or less of Fe, 0.50 mass % or less and preferably 0.30 mass % or less of Cu, 1.50 mass % or less and preferably 1.20 mass % or less of Mn, 0.20 mass % or less and preferably 0.10 mass % or less of Cr, 2.0 mass % or less and preferably 1.5 mass % or less of Zn, and 0.20 mass % or less and preferably 0.15 mass % or less of Ti.

The sacrificial anode material according to the aluminum alloy brazing sheet of the present invention is formed of an aluminum alloy comprising 0.50 mass % to 3.00 mass % and preferably 0.50 mass % to 2.50 mass % of Zn. The sacrificial anode material according to the aluminum alloy brazing sheet of the present invention refers to a layer that is electrochemically more active, that is, potentially less noble than the core material is. The sacrificial anode material is not particularly limited as long as the sacrificial anode material is potentially less noble than the core material is. Examples of the sacrificial anode material include Al—Zn-based alloys such as a 7072 alloy.

As the sacrificial anode material, a sacrificial anode material (1) described below may be exemplified. The sacrificial anode materials (1) is formed of an aluminum alloy comprising 0.50 mass % to 3.00 mass % and preferably 0.50 mass % to 2.50 mass % of Zn, with the balance being Al and inevitable impurities. The sacrificial anode materials (1) may further comprise one or two or more elements of 0.60 mass % or less and preferably 0.50 mass % or less of Si, 0.50 mass % or less and preferably 0.40 mass % or less of Fe, 0.20 mass % or less and preferably 0.10 mass % or less of Cu, 0.20 mass % or less and preferably 0.10 mass % or less of Mn, 0.20 mass % or less and preferably 0.10 mass % or less of Mg, 0.20 mass % or less and preferably 0.10 mass % or less of Cr, and 0.20 mass % or less and preferably 0.15 mass % or less of Ti.

In the case where the aluminum alloy brazing sheet of the present invention comprises two or more brazing materials, these brazing materials may comprise the same composition or different compositions. In the case where the aluminum alloy brazing sheet of the present invention comprises two or more intermediate layers, these intermediate layers may comprise the same composition or different compositions.

In the aluminum alloy brazing sheet of the present invention, the ratio (%) of the thickness of the core material to the thickness of the aluminum alloy brazing sheet ((thickness of core material/thickness of aluminum alloy brazing sheet)×100) is 60% to 95% and preferably 70% to 90%. The ratio of the thickness of the core material to the thickness of the aluminum alloy brazing sheet within the above range allows the overall strength of the brazing sheet to be improved. On the other hand, a ratio of the thickness of the core material to the thickness of the aluminum alloy brazing sheet of less than the above range may cause overall strength of the brazing sheet to decrease. A ratio of the thickness of the core material to the thickness of the aluminum alloy brazing sheet of more than the above range may cause the thickness of the brazing material layer and the intermediate layer to be insufficient and thus the brazing properties to deteriorate.

With respect to the aluminum alloy brazing sheet according to the first embodiment of the present invention, in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 150±5° C. for 60±5 minutes, a value of tensile strength in terms of the core material alone of the aluminum alloy brazing sheet after the heating and high temperature retention test is 220 MPa or more and preferably 230 MPa or more. In the heating and high temperature retention test according to the present invention, a value of tensile strength in terms of the core material alone of the aluminum alloy brazing sheet after the heating and high temperature retention test of 220 MPa or more allows high temperature aging after brazing, specifically, aging treatment for 60 minutes to 120 minutes at 140° C. to 160° C. to improve the strength of the member in a shorter time than in the case where a low temperature aging at room temperature is performed. A higher value of tensile strength in terms of the core material alone of the aluminum alloy brazing sheet after the heating and high temperature retention test is more preferable. The upper limit value is, for example, 300 MPa.

With respect to the aluminum alloy brazing sheet according to the second embodiment of the present invention, in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 170±5° C. for 40±5 minutes, a value of tensile strength in terms of the core material alone of the aluminum alloy brazing sheet after the heating and high temperature retention test is 220 MPa or more and preferably 230 MPa or more. In the heating and high temperature retention test according to the present invention, a value of tensile strength in terms of the core material alone of the aluminum alloy brazing sheet after the heating and high temperature retention test of 220 MPa or more allows high temperature aging after brazing, specifically, aging treatment for 40 minutes to 80 minutes at 160° C. to 180° C. to improve the strength of the member in a shorter time than in the case where a low temperature aging at room temperature is performed. A higher value of tensile strength in terms of the core material alone of the aluminum alloy brazing sheet after the heating and high temperature retention test is more preferable. The upper limit value is, for example, 300 MPa.

With respect to the aluminum alloy brazing sheet according to the third embodiment of the present invention, in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 190±5° C. for 5±2 minutes, a value of tensile strength in terms of the core material alone of the aluminum alloy brazing sheet after the heating and high temperature retention test is 220 MPa or more and preferably 230 MPa or more. In the heating and high temperature retention test according to the present invention, a value of tensile strength in terms of the core material alone of the aluminum alloy brazing sheet after the heating and high temperature retention test of 220 MPa or more allows high temperature aging after brazing, specifically, aging treatment for 3 minutes to 60 minutes at 180° C. to 200° C. to improve the strength of the member in a shorter time than in the case where a low temperature aging at room temperature is performed. A higher value of tensile strength in terms of the core material alone of the aluminum alloy brazing sheet after the heating and high temperature retention test is more preferable. The upper limit value is, for example, 300 MPa.

With respect to the aluminum alloy brazing sheet according to the fourth embodiment of the present invention, in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 210±5° C. for 5±2 minutes, a value of tensile strength in terms of the core material alone of the aluminum alloy brazing sheet after the heating and high temperature retention test is 220 MPa or more and preferably 230 MPa or more. In the heating and high temperature retention test according to the present invention, a value of tensile strength in terms of the core material alone of the aluminum alloy brazing sheet after the heating and high temperature retention test of 220 MPa or more allows high temperature aging after brazing, specifically, aging treatment for 3 minutes to 60 minutes at 200° C. to 220° C. to improve the strength of the member in a shorter time than in the case where a low temperature aging at room temperature is performed. A higher value of tensile strength in terms of the core material alone of the aluminum alloy brazing sheet after the heating and high temperature retention test is more preferable. The upper limit value is, for example, 300 MPa.

With respect to the aluminum alloy brazing sheet according to the fifth embodiment of the present invention, in a heating and low temperature retention test in which a temperature is raised to a heating retention temperature at an average temperature rising rate of 50° C./min to 150° C./min, retained for 3±2 minutes at 600±10° C., subsequently dropped from the heating retention temperature to a low retention temperature at an average temperature falling rate of 20° C./min to 120° C./min, and thereafter retained for 336±5 hours at 25±5° C., a value of tensile strength in terms of the core material alone of the aluminum alloy brazing sheet after the heating and low temperature retention test is 220 MPa or more and preferably 230 MPa or more. In the heating and low temperature retention test according to the present invention, a value of tensile strength in terms of the core material alone of the aluminum alloy brazing sheet after the heating and low temperature retention test of 220 MPa or more allows the strength of the member to be improved by the room temperature aging after brazing and preferably the room temperature aging after brazing for 168 hours to 336 hours at a temperature of 25±5° C. A higher value of the tensile strength in terms of the core material alone of the aluminum alloy brazing sheet after the heating and low temperature retention test is more preferable. The upper limit value is, for example, 300 MPa.

In the present invention, the value of the tensile strength in terms of the core material alone of the aluminum alloy brazing sheet is a value calculated in accordance with the following calculation formula (1) based on the value obtained by performing a tensile strength test of the aluminum alloy brazing sheet after the heating and low temperature retention test in accordance with JIS Z2241, and measuring a stress value (tensile strength) at break of the aluminum alloy brazing sheet.

$$σ c = ( σ t - ( rf \times σ f + ri \times σ i + rs \times σ s ) ) / rc \qquad ( 1 )$$

(In the formula, cc is the tensile strength value (MPa) of the aluminum alloy brazing sheet in terms of the core material alone; ct is the tensile strength (MPa) of the aluminum alloy brazing sheet; cf is the tensile strength (MPa) of the brazing material; ci is the tensile strength (MPa) of the intermediate layer; and cs is the tensile strength (MPa) of the sacrificial anode material; and rc is the ratio of the thickness of the core material (a value of “core material thickness/entire sheet thickness”); rf is the ratio of the thickness of the brazing material layer (a value of “brazing material thickness/entire sheet thickness”); ri is the ratio of the thickness of the intermediate layer (a value of “intermediate layer thickness/entire sheet thickness”); and rs is the ratio of the thickness of the sacrificial anode material (a value of “sacrificial anode material thickness/entire sheet thickness”).

Here, in the case where alloys are applied, the alloys comprising different compositions of the brazing material and the intermediate material between one side surface and the other side surface of the core material, for example, in the case where a brazing material having a tensile strength of σf1 (MPa) is cladded on one side surface of the core material at a thickness ratio of rf1 and a brazing material having a tensile strength of σf2 (MPa) is cladded on the other side surface at a thickness ratio of rf2, the sum of the values obtained by multiplying the tensile strength and the ratio of thickness of each layer such as “rf1×σf1 (one side surface)+rf2×σf2 (other side surface)” is used for the value of “rf×σf” in the formula (1). For example, in the case where an intermediate layer having a tensile strength of σi1 (MPa) is cladded on one side surface of the core material at a thickness ratio of ri1 and an intermediate layer having a tensile strength of σi2 (MPa) is cladded on the other side surface at a thickness ratio of ri2, the sum of the values obtained by multiplying the tensile strength and the ratio of thickness of each layer such as “ri1×σi1 (one side surface)+ri2×σi2 (other side surface)” is used for the value of “ri×σi” in the formula (1). With respect to the tensile strength of each layer, literature values for the tensile strength of each material may be used in the case where common alloys are used. For example, in the case where 4343, 4045, 4047, or the like is used for the brazing material or 1100, 3003, or the like is used for the intermediate layer, these published literature values may be used for calculation.

With respect to the aluminum alloy brazing sheet according to the sixth embodiment of the present invention, in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 150±5° C. for 60±5 minutes, a Vickers hardness of a core material part cross-section of the aluminum alloy brazing sheet after the heating and high temperature retention test is 66 or more. In the heating and high temperature retention test according to the present invention, a Vickers hardness of the core material part cross-section of the aluminum alloy brazing sheet after the heating and high temperature retention test of 66 or more and preferably 69 or more allows high temperature aging after brazing, specifically, aging treatment at 140° C. to 160° C. for 60 minutes to 120 minutes to improve the strength of the member in a shorter time than in the case where room temperature aging is performed. A higher Vickers hardness of the core material part cross-section of the aluminum alloy brazing sheet after the heating and high temperature retention test is more preferable. The upper limit value is, for example, 90.

With respect to the aluminum alloy brazing sheet according to the seventh embodiment of the present invention, in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 170±5° C. for 40±5 minutes, a Vickers hardness of a core material part cross-section of the aluminum alloy brazing sheet after the heating and high temperature retention test is 66 or more. In the heating and high temperature retention test according to the present invention, a Vickers hardness of the core material part cross-section of the aluminum alloy brazing sheet after the heating and high temperature retention test of 66 or more and preferably 69 or more allows high temperature aging after brazing, specifically, aging treatment at 160° C. to 180° C. for 40 minutes to 80 minutes to improve the strength of the member in a shorter time than in the case where room temperature aging is performed. A higher Vickers hardness of the core material part cross-section of the aluminum alloy brazing sheet after the heating and high temperature retention test is more preferable. The upper limit value is, for example, 90.

With respect to the aluminum alloy brazing sheet according to the eighth embodiment of the present invention, in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 190±5° C. for 20±5 minutes, a Vickers hardness of a core material part cross-section of the aluminum alloy brazing sheet after the heating and high temperature retention test is 66 or more. In the heating and high temperature retention test according to the present invention, a Vickers hardness of the core material part cross-section of the aluminum alloy brazing sheet after the heating and high temperature retention test of 66 or more and preferably 69 or more allows high temperature aging after brazing, specifically, aging treatment at 180° C. to 200° C. for 3 minutes to 60 minutes to improve the strength of the member in a shorter time than in the case where room temperature aging is performed. A higher Vickers hardness of the core material part cross-section of the aluminum alloy brazing sheet after the heating and high temperature retention test is more preferable. The upper limit value is, for example, 90.

With respect to the aluminum alloy brazing sheet according to the ninth embodiment of the present invention, in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 210±5° C. for 20±5 minutes, a Vickers hardness of a core material part cross-section of the aluminum alloy brazing sheet after the heating and high temperature retention test is 66 or more. In the heating and high temperature retention test according to the present invention, a Vickers hardness of the core material part cross-section of the aluminum alloy brazing sheet after the heating and high temperature retention test of 66 or more and preferably 69 or more allows high temperature aging after brazing, specifically, aging treatment at 200° C. to 220° C. for 3 minutes to 60 minutes to improve the strength of the member in a shorter time than in the case where room temperature aging is performed. A higher Vickers hardness of the core material part cross-section of the aluminum alloy brazing sheet after the heating and high temperature retention test is more preferable. The upper limit value is, for example, 90.

With respect to the aluminum alloy brazing sheet according to the tenth embodiment of the present invention, in a heating and low temperature retention test in which a temperature is raised to a heating retention temperature at an average temperature rising rate of 50° C./min to 150° C./min, retained for 3±2 minutes at 600±10° C., subsequently dropped from the heating retention temperature to a low retention temperature at an average temperature falling rate of 20° C./min to 120° C./min, and thereafter retained for 336±5 hours at 25±5° C., a Vickers hardness of a core material part cross-section of the aluminum alloy brazing sheet after the heating and low temperature retention test is 66 or more. In the heating and low temperature retention test according to the present invention, a Vickers hardness of the core material part cross-section of the aluminum alloy brazing sheet after the heating and low temperature retention test of 66 or more and more preferably 69 or more allows the strength of the member to be improved by the room temperature aging after brazing, and preferably the room temperature aging after brazing for 168 hours to 336 hours at a temperature of 25±5° C. A higher Vickers hardness of the core material part cross-section of the aluminum alloy brazing sheet after the heating and low temperature retention test is more preferable. The upper limit value is, for example, 90.

In the present invention, the Vickers hardness of the core material part cross-section of the aluminum alloy brazing sheet after the heating and low temperature retention test is measured by a method in accordance with JIS Z2244. It has been known that the approximate formula “σ=3.34 Hv” is established between tensile strength and Vickers hardness, and thus Vickers hardness can be determined by dividing the tensile strength of the core material obtained from the tensile test by 3.34.

As the preferable conditions of the heating and high temperature retention test according to the aluminum alloy brazing sheets of the first to fourth and the sixth to ninth embodiments of the present invention, a temperature is raised from 300° C. to 400° C. at an average temperature rising rate of 10° C./min to 100° C./min, raised from 400° C. to 580° C. for 2 minutes to 10 minutes, raised from 580° C. to the heating retention temperature within 5 minutes, retained for 3±2 minutes at 600±10° C., subsequently dropped from the heating retention temperature to room temperature at an average temperature falling rate of 20° C./min to 120° C./min, and thereafter retained at 150±5° C. for 60±5 minutes (the first embodiment and the sixth embodiment), at 170±5° C. for 40±5 minutes (the second embodiment and the seventh embodiment), at 190±5° C. for 5±2 minutes (the third embodiment and the eighth embodiment), or at 210±5° C. for 5±2 minutes (the fourth embodiment and the ninth embodiment).

As the preferable conditions of the heating and low temperature retention test according to the aluminum alloy brazing sheets of the fifth and tenth embodiments of the present invention, a temperature is raised from 300° C. to 400° C. at an average temperature rising rate of 20° C./min to 100° C./min, raised from 400° C. to 580° C. for 2 minutes to 10 minutes, raised from 580° C. to the heating retention temperature within 5 minutes, retained at 600±10° C. for 3±2 minutes, subsequently dropped from the heating retention temperature to the low retention temperature at an average temperature falling rate of 20° C./min to 120° C./min, and retained at 25±5° C. for 336±5 hours.

The aluminum alloy brazing sheets of the first to fourth embodiments of the present invention do not have excessively low solidus temperature due to comprising the above chemical compositions, and thus defects caused by melting the member during brazing can be prevented and the strength of the member can be improved in a shorter time than in the case where a room temperature aging is performed, due to having a value of tensile strength in terms of the core material alone of the aluminum alloy brazing sheet in the heating and high temperature retention test of 220 MPa or more.

The aluminum alloy brazing sheet of the fifth embodiment of the present invention does not have excessively low solidus temperature due to comprising the above chemical compositions, and thus defects caused by melting of the member during brazing can be prevented and the strength of the member can be improved by the room temperature aging after brazing, preferably by the room temperature aging after brazing at 25±5° C. for 168 hours to 336 hours due to having a value of tensile strength in terms of the core material alone of the aluminum alloy brazing sheet in the heating and low temperature retention test of 220 MPa or more.

The aluminum alloy brazing sheets of the sixth to ninth embodiments of the present invention do not have excessively low solidus temperature due to comprising the above chemical compositions, and thus defects caused by melting of the member during brazing can be prevented and the strength of the member can be improved in a shorter time than in the case where a room temperature aging is performed, due to having a Vickers hardness of the core material part cross-section of the aluminum alloy brazing sheet in the heating and high temperature retention test of 66 or more.

The aluminum alloy brazing sheet of the tenth embodiment of the present invention does not have excessively low solidus temperature due to comprising the above chemical compositions, and thus defects caused by melting of the member during brazing can be prevented and the strength of the member can be improved by the room temperature aging after brazing, preferably by the room temperature aging after brazing for 168 hours to 336 hours at 25±5° C. due to having a Vickers hardness of the core material part cross-section of the aluminum alloy brazing sheet in the heating and low temperature retention test of 66 or more.

Methods for producing the aluminum alloy brazing sheets of the first to tenth embodiments of the present invention are not particularly limited. The aluminum alloy brazing sheet of the present invention is suitably produced by the method for producing an aluminum alloy brazing sheet of the first embodiment of the present invention, the method for producing an aluminum alloy brazing sheet of the second embodiment of the present invention, or the method for producing an aluminum alloy brazing sheet of the third embodiment of the present invention described below.

The method for producing an aluminum alloy brazing sheet of the present invention is a method for producing an aluminum alloy brazing sheet including a multilayer for an aluminum alloy heat exchanger, the method comprising:
a casting step of casting an ingot for a core material formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities;
a homogenization treatment step of heating the ingot for a core material at 400° C. to 540° C.;
a hot rolling step of stacking a hot-rolled ingot for a clad material onto the ingot for a core material to perform hot rolling; and
a cold rolling step.

In the method for producing an aluminum alloy brazing sheet of the first embodiment of the present invention, final annealing treatment of heating at 350° C. or more is performed after performing the cold rolling step. In the method for producing an aluminum alloy brazing sheet of the second embodiment of the present invention, final annealing treatment of heating at less than 350° C. is performed after performing the cold rolling step. In the method for producing an aluminum alloy brazing sheet of the third embodiment of the present invention, intermediate annealing treatment of heating at 350° C. or more is performed in the course of the cold rolling step.

Namely, the method for producing an aluminum alloy brazing sheet of the first embodiment of the present invention is a method for producing an aluminum alloy brazing sheet including a multilayer for an aluminum alloy heat exchanger, the method comprising:
a casting step of casting an ingot for a core material formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities;
a homogenization treatment step of heating the ingot for a core material at 400° C. to 540° C.;
a hot rolling step of stacking a hot-rolled ingot for a clad material onto the ingot for a core material to perform hot rolling;
a cold rolling step; and
a final annealing treatment step of heating at 350° C. or more after performing the cold rolling step.

The method for producing an aluminum alloy brazing sheet of the second embodiment of the present invention is a method for producing an aluminum alloy brazing sheet including a multilayer for an aluminum alloy heat exchanger, the method comprising:
a casting step of casting an ingot for a core material formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities;
a homogenization treatment step of heating the ingot for a core material at 400° C. to 540° C.;
a hot rolling step of stacking a hot-rolled ingot for a clad material onto the ingot for a core material to perform hot rolling;
a cold rolling step; and
a final annealing treatment step of heating at less than 350° C. after performing the cold rolling step.

The method for producing an aluminum alloy brazing sheet of the third embodiment of the present invention is a method for producing an aluminum alloy brazing sheet including a multilayer for an aluminum alloy heat exchanger, the method comprising:
a casting step of casting an ingot for a core material formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities;
a homogenization treatment step of heating the ingot for a core material at 400° C. to 540° C.;
a hot rolling step of stacking a hot-rolled ingot for a clad material onto the ingot for a core material to perform hot rolling;
a cold rolling step; and
an intermediate annealing treatment step of heating at 350° C. or more in the course of the cold rolling step.

Hereinafter, the common points of the method for producing an aluminum alloy brazing sheet of the first embodiment of the present invention, the method for producing an aluminum alloy brazing sheet of the second embodiment of the present invention, and the method for producing an aluminum alloy brazing sheet of the third embodiment of the present invention will be described as description as the method for producing an aluminum alloy brazing sheet of the present invention by collectively referring to the method for producing an aluminum alloy brazing sheet of the first embodiment of the present invention, the method for producing an aluminum alloy brazing sheet of the second embodiment of the present invention, and the method for producing an aluminum alloy brazing sheet of the third embodiment of the present invention.

In the method for producing an aluminum alloy brazing sheet of the present invention, an aluminum alloy brazing sheet including a multilayer in which one or more clad materials are cladded to the core material is produced.

The casting step according to the method for producing an aluminum alloy brazing sheet of the present invention is a step for producing aluminum alloy ingots (slabs) each comprising a predetermined chemical composition, that is, an ingot for the core material and an ingot for the clad material by a direct chill (DC) casting method. The DC casting method is not particularly limited and common methods may be used.

The ingot for the core material is formed of an aluminum alloy comprising 0.20 mass % to 1.00 mass % and preferably 0.40 mass % to 0.90 mass % of Si, 0.10 mass % to 0.80 mass % and preferably 0.30 mass % to 0.80 mass % of Mn, and 0.20 mass % to 1.00 mass % and preferably 0.40 mass % to 0.90 mass % of Mg, having a value of “Mn content (mass %)/Si content (mass %)” of 0.10 or more and less than 1.00 and preferably 0.20 or more and less than 0.90, a value of “Mg content (mass %)+Si content (mass %)” of 0.60 mass % or more and less than 1.60 mass % and preferably 0.80 mass % or more and less than 1.50 mass %, a Fe content of 0.40 mass % or less and preferably 0.35 mass % or less, a Cu content of 0.25 mass % or less, preferably 0.20 mass % or less, and more preferably 0.05 mass % to 0.20 mass %, a Cr content of 0.10 mass % or less, preferably 0.05 mass % or less, and more preferably 0.001 mass % to 0.05 mass %, a Zn content of 2.00 mass % or less, preferably 1.50 mass % or less, and more preferably 0.05 mass % to 1.50 mass %, a Ti content of 0.20 mass % or less, preferably 0.15 mass % or less, and more preferably 0.10 mass % or less (the Ti content is preferably 0.001 mass % or more), and a Zr content of 0.10 mass % or less, preferably 0.05 mass % or less, and more preferably 0.001 mass % to 0.05 mass % or less with the balance being Al and inevitable impurities.

In the case where the aluminum alloy brazing sheets of the first to fourth and sixth to ninth embodiments of the present invention are produced, the value of “Mn content (mass %)/Si content (mass %)” of the ingot for the core material is more preferably 0.25 or more and less than 0.85 and further preferably 0.30 or more and less than 0.80.

In the case where the aluminum alloy brazing sheets of the fifth and tenth embodiments of the present invention are produced, the value of “Mn content (mass %)/Si content (mass %)” of the ingot for the core material is more preferably 0.25 or more and less than 0.85 and further preferably 0.30 or more and less than 0.80.

The ingot for the clad material is an ingot for the brazing material, an ingot for the intermediate layer, or an ingot for the sacrificial anode material and is selected depending on the constitution of the clad material of the aluminum alloy brazing sheet being the target for production.

The ingot for the brazing material is formed of an aluminum alloy comprising 5.00 mass % to 13.00 mass % and preferably 6.00 mass % to 13.00 mass % of Si. Examples of the ingot for the brazing material include Al—Si-based alloys such as a 4343 alloy, a 4045 alloy, and a 4047 alloy.

As the ingot for the brazing material, an ingot for the brazing material (1) described below may be exemplified. The brazing material (1) is formed of an aluminum alloy comprising 5.00 mass % to 13.00 mass % and preferably 6.00 mass % to 13.00 mass % of Si, with the balance being Al and inevitable impurities. The brazing material (1) may further comprise one or two or more elements of 0.80 mass % or less and preferably 0.70 mass % or less of Fe, 0.30 mass % or less and preferably 0.25 mass % or less of Cu, 0.20 mass % or less and preferably 0.15 mass % or less of Mn, 0.10 mass % or less and preferably 0.05 mass % or less of Mg, 0.10 mass % or less and preferably 0.05 mass % or less of Cr, 0.20 mass % or less and preferably 0.10 mass % or less of Zn, and 0.20 mass % or less and preferably 0.10 mass % or less of Ti.

The ingot for the intermediate layer is formed of an aluminum alloy having a Mg content of 0.20 mass % or less and preferably 0.10 mass % or less. Examples of ingot for the intermediate layer include 1000 series alloys, Al—Mn-based alloys, and Al—Zn-based alloys.

As the ingot for the intermediate layer, an ingot for the intermediate layer (1) described below may be exemplified. The intermediate layer (1) is formed of an aluminum alloy comprising 0.20 mass % or less and preferably 0.10 mass % or less of Mg, with the balance being Al and inevitable impurities. The intermediate layer (1) may further comprise one or two or more elements of 0.60 mass % or less and preferably 0.50 mass % or less of Si, 0.70 mass % or less and preferably 0.60 mass % or less of Fe, 0.50 mass % or less and preferably 0.30 mass % or less of Cu, 1.50 mass % or less and preferably 1.20 mass % or less of Mn, 0.20 mass % or less and preferably 0.10 mass % or less of Cr, 2.0 mass % or less and preferably 1.5 mass % or less of Zn, and 0.20 mass % or less and preferably 0.15 mass % or less of Ti.

The ingot for the sacrificial anode material is formed of an aluminum alloy comprising 0.50 mass % to 3.00 mass % and preferably 0.50 mass % to 2.50 mass % of Zn. Examples of the ingot for the sacrificial anode material include Al—Zn-based alloys such as a 7072 alloy.

As the ingot for the sacrificial anode material, an ingot for the sacrificial anode material (1) described below may be exemplified. The sacrificial anode materials (1) is formed of an aluminum alloy comprising 0.50 mass % to 3.00 mass % and preferably 0.50 mass % to 2.50 mass % of Zn, with the balance being Al and inevitable impurities. The sacrificial anode materials (1) may further comprise one or two or more elements of 0.60 mass % or less and preferably 0.50 mass % or less of Si, 0.50 mass % or less and preferably 0.40 mass % or less of Fe, 0.20 mass % or less and preferably 0.10 mass % or less of Cu, 0.20 mass % or less and preferably 0.10 mass % or less of Mn, 0.20 mass % or less and preferably 0.10 mass % or less of Mg, 0.20 mass % or less and preferably 0.10 mass % or less of Cr, and 0.20 mass % or less and preferably 0.15 mass % or less of Ti.

The homogenization treatment according to the method for producing an aluminum alloy brazing sheet of the present invention is treatment in which the ingot for the core material is heated at 400° C. to 540° C. The heating temperature at the homogenization treatment is 400° C. to 540° C. and preferably 420° C. to 520° C. The heating temperature of the homogenization treatment within the above range allows hot workability to be improved by promoting fine fragment formation of the coarse crystallized product generated during casting and Si and Mn formed during casting as the solid solution in the mother phase to be finely precipitated as an Al—Mn—Si compound, whereby the aluminum alloy brazing sheet having a value of tensile strength in terms of the core material alone of the aluminum alloy brazing sheet after the heating and high temperature retention test or the heating and low temperature retention test according to the present invention of 220 MPa or more or the aluminum alloy brazing sheet having a Vickers hardness of the core material part cross-section of the aluminum alloy brazing sheet after the heating and low temperature retention test according to the present invention of 66 or more can be obtained. On the other hand, a heating temperature of the homogenization treatment of less than the above range may cause the fine fragment formation of the crystallized product to be insufficient to deteriorate the hot workability, whereas a heating temperature of the homogenization treatment of more than the above range may cause the coarse Al—Mn—Si compound to be precipitated. Consequently, sufficient strength after brazing and room temperature aging may fail to be achieved. The heating time for the homogenization treatment is 4 hours or more and preferably 6 hours or more. The heating time of the homogenization treatment within the above range allows the aluminum alloy brazing sheet having a value of tensile strength in terms of the core material alone of the aluminum alloy brazing sheet after the heating and high temperature retention test or the heating and low temperature retention test according to the present invention of 220 MPa or more or the aluminum alloy brazing sheet having a Vickers hardness of the core material part cross-section of the aluminum alloy brazing sheet after the heating and high temperature retention test or the heating and low temperature retention test according to the present invention of 66 or more to be obtained. On the other hand, a heating time of the homogenization treatment of less than the above range results in not obtaining the aluminum alloy brazing sheet having a value of tensile strength in terms of the core material alone of the aluminum alloy brazing sheet after the heating and high temperature retention test or the heating and low temperature retention test according to the present invention of 220 MPa or more or the aluminum alloy brazing sheet having a Vickers hardness of the core material part cross-section of the aluminum alloy brazing sheet after the heating and high temperature retention test or the heating and low temperature retention test according to the present invention of 66 or more. A heating time of the homogenization treatment of more than 24 hours results in saturation in the effect of the homogenization treatment. The treatment performed for more than 24 hours results in expecting no further effect and thus is not preferable from an economic viewpoint. The heating time of the homogenization treatment is preferably 18 hours or less from the economic viewpoint.

The hot rolling step according to the method for producing an aluminum alloy brazing sheet of the present invention is a step of stacking a hot-rolled predetermined ingot for the clad material onto the ingot for the core material subjected to the homogenization treatment to form a product in which the hot-rolled ingot for the clad material is stacked onto the ingot for the core material, and subjecting the product to hot rolling.

As aspects of the stack of the ingot for the core material subjected to the homogenization treatment and the hot-rolled ingot for the clad material, the followings are included.
(1) Ingot for brazing material/ingot for intermediate layer/ingot for core material
(2) Ingot for brazing material/ingot for intermediate layer/ingot for core material/ingot for sacrificial anode material
(3) Ingot for brazing material/ingot for intermediate layer/ingot for core material/ingot for intermediate layer/ingot for brazing material

In the hot rolling step, the rolling temperature for hot rolling is in accordance with common methods and can be set to a range not exceeding the solidus temperature of each material.

The cold rolling step according to the method for producing an aluminum alloy brazing sheet of the present invention is a step of performing cold rolling of the sheet material after hot rolling obtained by performing the hot rolling step. In the cold rolling step, cold rolling is performed in one or two or more passes. In the cold rolling, cold rolling is performed until the thickness of the sheet material reaches a predetermined thickness. In the cold rolling step, the number of cold rolling passes is not particularly limited and is selected as appropriate.

The method for producing an aluminum alloy brazing sheet of the first embodiment of the present invention comprises final annealing treatment (1) in which the sheet is heated at 350° C. or more after performing the cold rolling step. In the final annealing treatment (1), the heating temperature is 350° C. or more and preferably 360° C. to 450° C. and the heating time is 1 hour to 5 hours. The method for producing an aluminum alloy brazing sheet of the first embodiment of the present invention comprises the final annealing treatment (1) to give an O material aluminum alloy brazing sheet.

The method for producing an aluminum alloy brazing sheet of the second embodiment of the present invention comprises final annealing treatment (2) in which the sheet is heated at less than 350° C. after performing the cold rolling step. In the final annealing treatment (2), the heating temperature is less than 350° C. and preferably 250° C. to 340° C. and the heating time is 1 hour to 10 hours. The method for producing an aluminum alloy brazing sheet of the second embodiment of the present invention comprises the final annealing treatment (2) to give an H2n material aluminum alloy brazing sheet.

The method for producing an aluminum alloy brazing sheet of the third embodiment of the present invention comprises the intermediate annealing treatment in which the sheet is heated at 350° C. or more in the course of the cold rolling step. In the method for producing an aluminum alloy brazing sheet of the third embodiment of the present invention, the intermediate annealing treatment is performed at least once during the cold rolling passes when two or more cold rolling passes are performed in the cold rolling step. In the intermediate annealing treatment, the heating temperature is 350° C. or more and preferably 360° C. to 450° C. and the heating time is 1 hour to 5 hours. The method for producing an aluminum alloy brazing sheet of the third embodiment of the present invention comprises the intermediate annealing treatment to give an H1n material aluminum alloy brazing sheet.

In the method for producing an aluminum alloy brazing sheet of the present invention, the aluminum alloy brazing sheet having a value of tensile strength in terms of the core material alone of the aluminum alloy brazing sheet after the heating and high temperature retention test or the heating and low temperature retention test according to the present invention of 220 MPa or more or the aluminum alloy brazing sheet having a Vickers hardness of the core material part cross-section of the aluminum alloy brazing sheet after the heating and high temperature retention test or the heating and low temperature retention test according to the present invention of 66 or more can be obtained by determining the chemical composition of the ingot for the core material to the composition described above and performing the homogenization treatment by heating at 400° C. to 540° C. and preferably 420° C. to 520° C. for 4 hours or more, preferably 4 hours to 24 hours, and more preferably 6 hours to 18 hours.

In the method for producing an aluminum alloy brazing sheet of the first embodiment of the present invention, the aluminum alloy brazing sheet formed of the O material and having a value of tensile strength in terms of the core material alone of the aluminum alloy brazing sheet after the heating and high temperature retention test or the heating and low temperature retention test according to the present invention of 220 MPa or more or the aluminum alloy brazing sheet formed of the O material and having a Vickers hardness of the core material part cross-section of the aluminum alloy brazing sheet after the heating and high temperature retention test or the heating and low temperature retention test according to the present invention of 66 or more is obtained.

In the method for producing an aluminum alloy brazing sheet of the second embodiment of the present invention, the aluminum alloy brazing sheet formed of the H2n material and having a value of tensile strength in terms of the core material alone of the aluminum alloy brazing sheet after the heating and high temperature retention test or the heating and low temperature retention test according to the present invention of 220 MPa or more or the aluminum alloy brazing sheet formed of the H2n material and having a Vickers hardness of the core material part cross-section of the aluminum alloy brazing sheet after the heating and high temperature retention test or the heating and low temperature retention test according to the present invention of 66 or more is obtained.

In the method for producing an aluminum alloy brazing sheet of the third embodiment of the present invention, the aluminum alloy brazing sheet formed of the H1n material and having a value of tensile strength in terms of the core material alone of the aluminum alloy brazing sheet after the heating and high temperature retention test or the heating and low temperature retention test according to the present invention of 220 MPa or more or the aluminum alloy brazing sheet formed of the H1n material and having a Vickers hardness of the core material part cross-section of the aluminum alloy brazing sheet after the heating and high temperature retention test or the heating and low temperature retention test according to the present invention of 66 or more is obtained.

An aluminum alloy brazing sheet of an eleventh embodiment of the present invention is an aluminum alloy brazing sheet including a multilayer for an aluminum alloy heat exchanger obtained by performing a casting step of casting an ingot for a core material formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities;
a homogenization treatment step of heating the ingot for a core material at 400° C. to 540° C.;
a hot rolling step of stacking an ingot for a hot-rolled clad material onto the ingot for a core material to perform hot rolling;
a cold rolling step; and
a final annealing treatment step of heating at 350° C. or more after performing the cold rolling step.

The casting step, the homogenization treatment step, the hot rolling step, the cold rolling step, and the final annealing treatment step according to the aluminum alloy brazing sheet of the eleventh embodiment of the present invention are the same as the casting step, the homogenization treatment step, the hot rolling step, the cold rolling step, and the final annealing treatment step according to the method for producing an aluminum alloy brazing sheet of the first embodiment of the present invention.

An aluminum alloy brazing sheet of a twelfth embodiment of the present invention is an aluminum alloy brazing sheet including a multilayer for an aluminum alloy heat exchanger obtained by performing
a casting step of casting an ingot for a core material formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities;
a homogenization treatment step of heating the ingot for a core material at 400° C. to 540° C.;
a hot rolling step of stacking an ingot for a hot-rolled clad material onto the ingot for a core material to perform hot rolling;
a cold rolling step; and
a final annealing treatment step of heating at less than 350° C. after performing the cold rolling step.

The casting step, the homogenization treatment step, the hot rolling step, the cold rolling step, and the final annealing treatment step according to the aluminum alloy brazing sheet of the twelfth embodiment of the present invention are the same as the casting step, the homogenization treatment step, the hot rolling step, the cold rolling step, and the final annealing treatment step according to the method for producing an aluminum alloy brazing sheet of the second embodiment of the present invention.

An aluminum alloy brazing sheet of a thirteenth embodiment of the present invention is an aluminum alloy brazing sheet including a multilayer for an aluminum alloy heat exchanger obtained by performing
a casting step of casting an ingot for a core material formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities;
a homogenization treatment step of heating the ingot for a core material at 400° C. to 540° C.;
a hot rolling step of stacking an ingot for a hot-rolled clad material onto the ingot for a core material to perform hot rolling;
a cold rolling step; and
an intermediate annealing treatment step of heating at 350° C. or more in the course of the cold rolling step.

The casting step, the homogenization treatment step, the hot rolling step, the cold rolling step, and the intermediate annealing treatment step according to the aluminum alloy brazing sheet of the thirteenth embodiment of the present invention are the same as the casting step, the homogenization treatment step, the hot rolling step, the cold rolling step, and the intermediate annealing treatment step according to the method for producing an aluminum alloy brazing sheet of the third embodiment of the present invention.

A heat exchanger can be produced by combining the aluminum alloy brazing sheets of the first to thirteenth embodiments of the present invention and the aluminum alloy brazing sheets obtained by performing the methods for producing an aluminum alloy brazing sheet of the first to third embodiments of the present invention by press forming, or by forming these aluminum alloy brazing sheets into tubes and assembling other members such as a fin header to the tubes, and heating these products to perform brazing heating for brazing. Examples of brazing conditions include a heating condition of 600±10° C. for 1 minute to 5 minutes. The atmosphere, heating temperature, and time during brazing are not particularly limited and the brazing method is also not particularly limited.

Brazing-heated heat exchangers, for example, the brazing-heated formed products of the aluminum alloy brazing sheet of the first and sixth embodiments, subjected to artificial aging treatment by retaining at 140° C. to 160° C. for 60 minutes to 120 minutes after brazing heating allow the strength to be improved and thus higher strength than that of conventional products, that is, a tensile strength value of 220 MPa or more in terms of the core material alone after aging to be achieved.

Therefore, for example, as the method for producing a heat exchanger of the present invention, a method for producing a heat exchanger in which the formed product of the aluminum alloy brazing sheet of the first or sixth embodiment is subjected to brazing heating, for example, heating at 600±10° C., and thereafter artificial aging treatment of retaining at 140° C. to 160° C. for 60 minutes to 120 minutes to give a heat exchanger may be exemplified. The heating time at 600±10° C. is, for example, 1 minute to 5 minutes.

Brazing-heated heat exchangers, for example, the brazing-heated formed products of the aluminum alloy brazing sheet of the second and seventh embodiments, subjected to artificial aging treatment by retaining at 160° C. to 180° C. for 40 minutes to 80 minutes after brazing heating allow the strength to be improved and thus higher strength than that of conventional products, that is, a tensile strength value of 220 MPa or more in terms of the core material alone after aging to be achieved.

Therefore, for example, as the method for producing a heat exchanger of the present invention, a method for producing a heat exchanger in which the formed product of the aluminum alloy brazing sheet of the second or seventh embodiment is subjected to brazing heating, for example, heating at 600±10° C., and thereafter artificial aging treatment of retaining at 160° C. to 180° C. for 40 minutes to 80 minutes to give a heat exchanger may be exemplified. The heating time at 600±10° C. is, for example, 1 minute to 5 minutes.

Brazing-heated heat exchangers, for example, the brazing-heated formed products of the aluminum alloy brazing sheet of the third and eighth embodiments, subjected to artificial aging treatment by retaining at 180° C. to 200° C. for 5 minutes to 60 minutes after brazing heating allow the strength to be improved and thus higher strength than that of conventional products, that is, a tensile strength value of 220 MPa or more in terms of the core material alone after aging to be achieved.

Therefore, for example, as the method for producing a heat exchanger of the present invention, a method for producing a heat exchanger in which the formed product of the aluminum alloy brazing sheet of the third or eighth embodiment is subjected to brazing heating, for example, heating at 600±10° C., and thereafter artificial aging treatment of retaining at 180° C. to 200° C. for 5 minutes to 60 minutes to give a heat exchanger may be exemplified. The heating time at 600±10° C. is, for example, 1 minute to 5 minutes.

Brazing-heated heat exchangers, for example, the brazing-heated formed products of the aluminum alloy brazing sheet of the fourth and ninth embodiments, subjected to artificial aging treatment by retaining at 200° C. to 220° C. for 5 minutes to 60 minutes after brazing heating allow the strength to be improved and thus higher strength than that of conventional products, that is, a tensile strength value of 220 MPa or more in terms of the core material alone after aging to be achieved.

Therefore, for example, as the method for producing a heat exchanger of the present invention, a method for producing a heat exchanger in which the formed product of the aluminum alloy brazing sheet of the fourth or ninth embodiment is subjected to brazing heating, for example, heating at 600±10° C., and thereafter artificial aging treatment of retaining at 200° C. to 220° C. for 5 minutes to 60 minutes to give a heat exchanger may be exemplified. The heating time at 600±10° C. is, for example, 1 minute to 5 minutes.

The brazing-heated heat exchangers, for example, formed products of the fifth and tenth braze heated aluminum alloy brazing sheets subjected to room temperature aging for two weeks or more (336 hours or more) after brazing heating allow the strength to be improved and thus higher strength than that of conventional products, that is, a tensile strength value of 220 MPa or more in terms of the core material alone after aging to be achieved.

Therefore, for example, as the method for producing a heat exchanger of the present invention, a method for producing a heat exchanger in which the formed product of the aluminum alloy brazing sheet of the fifth or tenth embodiment is subjected to brazing heating, for example, heating at 600±10° C., and thereafter room temperature aging treatment for two weeks or more (336 hours or more) to give a heat exchanger may be exemplified. The heating time at 600±10° C. is, for example, 1 minute to 5 minutes.

In the method for producing a heat exchanger of the present invention, a heat exchanger comprising members having higher strength than that of conventional products is obtained through heating under predetermined conditions and thereafter applying artificial aging treatment or room temperature aging treatment under predetermined conditions.

Hereinafter, the present invention will be specifically described with reference to Examples. The present invention, however, is not limited to Examples described below.

### EXAMPLES

### Examples 1 and 2

Chemical compositions listed in Table 1 were cast to a thickness of 30 mm by continuous casting, thereafter subjected to homogenization treatment at 450° C. for 10 hours, and subjected to hot rolling at 480° C. to a thickness of 3 mm. Thereafter, cold rolling was performed to a thickness of 1.0 mm and final annealing treatment was performed at 400° C. for 1 hour to give a core material sample of an aluminum alloy brazing sheet. In Comparative Example 1, the same ingot as in Example 1 was subjected to homogenization treatment at 550° C. for 10 hours and all steps after the homogenization treatment are the same.

The obtained core material samples were subjected to calculation of solidus temperature, brazing heating and room temperature aging (a heating and low temperature retention test), and tensile testing and hardness measurement. The results are listed in Table 2.

In order to simplify the evaluation content, the evaluation was performed on the core material alone without cladding a brazing material, an intermediate layer, and a sacrificial anode material.

### <Brazing Heating and Room Temperature Aging (Heating and Low Temperature Retention Test)

The temperature of the core material sample was raised from 300° C. to 400° C. at an average temperature rising rate of 50° C./min, raised from 400° C. to 580° C. for 3 minutes, raised from 580° C. to the heating retention temperature for 1.5 minutes, retained at 600±10° C. for 3±2 minutes, subsequently dropped from the heating retention temperature to the low retention temperature at an average temperature falling rate of 70° C./min, and retained at 25±5° C. for 336 hours.

The above conditions of the brazing heating and the room temperature aging correspond to the conditions of the heating and low temperature retention tests according to the present invention.

### <Measurement of Tensile Strength>

The core material samples after the brazing heating and the room temperature aging (after the heating and low temperature retention test) were subjected to a tensile test in accordance with JIS Z2241 to measure tensile strength. A tensile strength of less than 220 MPa was determined as x, whereas a tensile strength of 220 MPa or more was determined as ◯.

The relationship between the tensile strength of the aluminum alloy brazing sheet and the tensile strength of the core material alone is as described above. When the tensile strength and a clad ratio of each layer are known, the tensile strength of the core material can be calculated from the tensile strength of the brazing sheet.

### <Measurement of Vickers Hardness of Core Material Part Cross-Section>

A tensile test was performed on the core material samples after the brazing heating and the room temperature aging (after the heating and high temperature retention test) and the obtained tensile strength values were divided by 3.34 to determine the Vickers hardness of the core material. Although the Vickers hardness was determined by calculation this time, the Vickers hardness may be determined in accordance with JIS Z2244 by mirror-polishing the cross section of the core material sample or brazing sheet after the brazing heating and the room temperature aging. An obtained Vickers hardness of less than 66 was determined as x, whereas an obtained Vickers hardness of 66 or more was determined as ◯.

### <Calculation of Solidus Temperature>

Thermodynamic calculation software (JMatPro) was used to calculate the solidus temperature of the core material sample. In the case where the solidus temperature was below 605° C., partial melting of members might occur due to temperature variation in actual brazing of heat exchangers. Therefore, the core material sample having a solidus temperature of 605° C. or more was determined as ◯, whereas the core material sample having a solidus temperature of less than 605° C. was determined to be x.

### Comparative Examples 1 to 4

Chemical compositions listed in Table 1 were cast to a thickness of 30 mm by continuous casting, thereafter subjected to homogenization treatment at 450° C. for 10 hours, and subjected to hot rolling at 480° C. to a thickness of 3 mm. Thereafter, cold rolling was performed to a thickness of 1.0 mm and final annealing treatment was performed at 400° C. for 1 hour to give a core material sample of an aluminum alloy brazing sheet.

The obtained core material samples were subjected to calculation of solidus temperature, brazing heating and room temperature aging (a heating and low temperature retention test), and tensile testing and hardness measurement. The results are listed in Table 2.

In order to simplify the evaluation content, the evaluation was performed on the core material alone without cladding a brazing material, an intermediate layer, and a sacrificial anode material.

### <Measurement of Tensile Strength and Measurement of Vickers Hardness of Core Material Part Cross-Section>

The same procedure was performed as in Examples 1 and 2. The results are listed in Table 4.

### <Evaluation Results>

Examples 1 and 2 of the present invention were both acceptable because the calculated values of the solidus temperature were 605° C. or more and the tensile strengths were 220 MPa or more.

On the other hand, although the calculated values of the solidus temperature of Comparative Examples 1 to 3 were 605° C. or more, the tensile strengths were less than 220 MPa, which were unacceptable. Comparative Example 4 was also unacceptable because the calculated value of the solidus temperature was less than 605° C.

TABLE 1

| | | | | | | | | | | | | Homogenization |
|---|---|---|---|---|---|---|---|---|---|---|---|---|
| | | | | | | | | | | | Mg + | temperature |
| | Si | Fe | Cu | Mn | Mg | Cr | Zn | Ti | Al | Mn/Si | Si | (° C.) |
| Example 1 | 0.59 | 0.19 | 0.00 | 0.19 | 0.61 | 0.00 | 0.00 | 0.01 | bal. | 0.32 | 1.20 | 450 |
| Example 2 | 0.59 | 0.19 | 0.14 | 0.19 | 0.61 | 0.00 | 0.49 | 0.01 | bal. | 0.32 | 1.20 | 450 |
| Comparative | 0.59 | 0.19 | 0.00 | 0.19 | 0.61 | 0.00 | 0.00 | 0.01 | bal. | 0.32 | 1.20 | 550 |
| Example 1 | | | | | | | | | | | | |
| Comparative | 0.59 | 0.19 | 0.00 | 0.00 | 0.61 | 0.00 | 0.00 | 0.01 | bal. | 0.00 | 1.20 | 450 |
| Example 2 | | | | | | | | | | | | |
| Comparative | 0.58 | 0.19 | 0.00 | 0.77 | 0.60 | 0.00 | 0.00 | 0.01 | bal. | 1.33 | 1.18 | 450 |
| Example 3 | | | | | | | | | | | | |
| Comparative | 0.81 | 0.25 | 0.00 | 0.15 | 0.80 | 0.00 | 0.00 | 0.01 | bal. | 0.19 | 1.61 | 450 |
| Example 4 | | | | | | | | | | | | |

The amount of each composition constituting the ingot listed in Table 1 means a value measured by inductively coupled plasma (ICP) optical emission spectrometry in accordance with JIS H 1305. Specifically, all raw materials of the ingot were charged into a casting furnace, melted, and stirred, and thereafter a sample for analysis prepared by pouring a small amount of melted metal from the obtained melted metal into a mold for analysis was measured by an inductively coupled plasma (ICP) optical emission spectrometer.

TABLE 2

| | Solidus temperature | | Tensile strength | | Vickers hardness | | |
|---|---|---|---|---|---|---|---|
| | | Evaluation | | Evaluation | | Evaluation | Comprehensive |
| | ° C. | result | MPa | result | Hv5 | result | evaluation |
| Example 1 | 616 | ◯ | 223 | ◯ | 67 | ◯ | ◯ |
| Example 2 | 607 | ◯ | 240 | ◯ | 72 | ◯ | ◯ |
| Comparative | 616 | ◯ | 214 | X | 64 | X | X |
| Example 1 | | | | | | | |
| Comparative | 610 | ◯ | 196 | X | 59 | X | X |
| Example 2 | | | | | | | |
| Comparative | 621 | ◯ | 179 | X | 54 | X | X |
| Example 3 | | | | | | | |
| Comparative | 595 | X | — | — | — | — | X |
| Example 4 | | | | | | | |

### Examples 3 to 8

The chemical compositions listed in Table 3 were cast to a thickness of 30 mm by continuous casting, thereafter subjected to homogenization treatment at 450° C. for 10 hours, and subjected to hot rolling at 480° C. to a thickness of 3 mm. Thereafter, cold rolling was performed to a thickness of 1.0 mm and final annealing treatment was performed at 400° C. for 1 hour to give a core material sample of an aluminum alloy brazing sheet.

The obtained core material samples were subjected to calculation of solidus temperature, brazing heating and artificial aging (heating and high temperature retention test), and tensile testing and hardness measurement. The results are listed in Table 4.

In order to simplify the evaluation content, the evaluation was performed on the core material alone without cladding a brazing material, an intermediate layer, and a sacrificial anode material.

### <Brazing Heating and Artificial Aging (Heating and High Temperature Retention Test)>

The temperature of the core material sample was raised from 300° C. to 400° C. at an average temperature rising rate of 50° C./min, raised from 400° C. to 580° C. for 3 minutes, raised from 580° C. to the heating retention temperature for 1.5 minutes, retained at 600±10° C. for 3±2 minutes, and subsequently dropped from the heating retention temperature to room temperature at an average temperature falling rate of 70° C./min. Thereafter, the artificial aging treatment was applied by retaining at the temperature and time listed in Table 4 (Examples 3, 4, 5, and 7).

The conditions of the brazing heating and the artificial aging in Examples 3, 4, 5, and 7 correspond to the conditions of the heating and high temperature retention tests of the present invention.

### <Measurement of Tensile Strength>

The core material samples after the brazing heating and the artificial aging (after the heating and high temperature retention test) were subjected to a tensile test in accordance with JIS Z2241 to measure tensile strength. A tensile strength of less than 220 MPa was determined as x, whereas a tensile strength of 220 MPa or more was determined as ◯.

The relationship between the tensile strength of the aluminum alloy brazing sheet and the tensile strength of the core material alone is as described above. When the tensile strength and a clad ratio of each layer are known, the tensile strength of the core material can be calculated from the tensile strength of the brazing sheet.

### <Measurement of Vickers Hardness of Core Material Part Cross-Section>

A tensile test was performed on the core material samples after the brazing heating and the artificial aging (after the heating and high temperature retention test) and the obtained tensile strength values were divided by 3.34 to determine the Vickers hardness of the core material. Although the Vickers hardness was determined by calculation this time, the Vickers hardness may be determined in accordance with JIS Z2244 by mirror-polishing the cross section of the core material sample or brazing sheet after the brazing heating and the room temperature aging. An obtained Vickers hardness of less than 66 was determined as x, whereas an obtained Vickers hardness of 66 or more was determined as ◯.

### Comparative Examples 5 to 7

The chemical compositions listed in Table 3 were cast to a thickness of 30 mm by continuous casting, thereafter subjected to homogenization treatment at 450° C. for 10 hours, and subjected to hot rolling at 480° C. to a thickness of 3 mm. Thereafter, cold rolling was performed to a thickness of 1.0 mm and final annealing treatment was performed at 400° C. for 1 hour to give a core material sample of an aluminum alloy brazing sheet.

The obtained core material samples were subjected to brazing heating and artificial aging (the heating and high temperature retention test), and tensile testing and hardness measurement. The results are listed in Table 4.

In order to simplify the evaluation content, the evaluation was performed on the core material alone without cladding a brazing material, an intermediate layer, and a sacrificial anode material.

### <Measurement of Tensile Strength and Measurement of Vickers Hardness of Core Material Part Cross-Section>

The same procedure was performed as in Examples 3 and 8. The results are listed in Table 4.

### <Evaluation Results>

Examples 3 to 8 of the present invention were all acceptable because tensile strengths were 220 MPa or more. The solidus temperature determined from the composition of the alloy 1 was 605° C. or more, which was acceptable.

On the other hand, Comparative Examples 5 to 7 of the present invention were unacceptable because the tensile strengths were less than 220 MPa.

TABLE 3

| | | | | | | | | | | | | Solidus |
|---|---|---|---|---|---|---|---|---|---|---|---|---|
| | Si | Fe | Cu | Mn | Mg | Cr | Zn | Ti | Al | Mn/Si | Mg + Si | temperature |
| Alloy 1 | 0.75 | 0.24 | 0.19 | 0.48 | 0.50 | 0.01 | 0.27 | 0.03 | bal. | 0.64 | 1.25 | 607° C. |

TABLE 4

| | Heat treatment conditions | | | Tensile strength | | Vickers hardness | | |
|---|---|---|---|---|---|---|---|---|
| | Retention | Retention | | | Evaluation | | Evaluation | Comprehension |
| | temperature | time | | MPa | result | Hv5 | result | evaluation |
| Example 3 | 150° C. | 60 | min. | 222 | ◯ | 66 | ◯ | ◯ |
| Example 4 | 170° C. | 40 | min. | 229 | ◯ | 69 | ◯ | ◯ |
| Example 5 | 190° C. | 5 | min. | 226 | ◯ | 68 | ◯ | ◯ |
| Example 6 | 190° C. | 20 | min. | 229 | ◯ | 69 | ◯ | ◯ |
| Example 7 | 210° C. | 5 | min. | 236 | ◯ | 71 | ◯ | ◯ |
| Example 8 | 210° C. | 20 | min. | 249 | ◯ | 75 | ◯ | ◯ |
| Comparative | 150° C. | 20 | min. | 216 | X | 65 | X | X |
| Example 5 | | | | | | | | |
| Comparative | 150° C. | 40 | min. | 218 | X | 65 | X | X |
| Example 6 | | | | | | | | |
| Comparative | 170° C. | 20 | min. | 217 | X | 65 | X | X |
| Example 7 | | | | | | | | |

21. An aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, in which the following any one of (a1) to (a5) is satisfied:
(a1) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 150±5° C. for 60±5 minutes, a value of tensile strength in terms of the core material alone of the aluminum alloy brazing sheet after the heating and high temperature retention test is 220 MPa or more,
(a2) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 170±5° C. for 40±5 minutes, a value of tensile strength in terms of the core material alone of the aluminum alloy brazing sheet after the heating and high temperature retention test is 220 MPa or more,
(a3) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 190±5° C. for 5±2 minutes, a value of tensile strength in terms of the core material alone of the aluminum alloy brazing sheet after the heating and high temperature retention test is 220 MPa or more,
(a4) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to room temperature at an average temperature falling rate of 20° C./min to 120° C./min, and thereafter retained at 210±5° C. for 5±2 minutes, a value of tensile strength in terms of the core material alone of the aluminum alloy brazing sheet after the heating and high temperature retention test is 220 MPa or more, and
(a5) in a heating and low temperature retention test in which a temperature is raised to a heating retention temperature at an average temperature rising rate of 50° C./min to 150° C./min, retained for 3±2 minutes at 600±10° C., subsequently dropped from the heating retention temperature to a low retention temperature at an average temperature falling rate of 20° C./min to 120° C./min, and thereafter retained for 336±5 hours at 25±5° C., a value of tensile strength in terms of the core material alone of the aluminum alloy brazing sheet after the heating and low temperature retention test is 220 MPa or more.

22. The aluminum alloy brazing sheet according to claim 21, comprising:
the multilayer including a three-layer material comprising an intermediate layer and a brazing material clad on one side surface of the core material in order of brazing material/intermediate material/core material, wherein
the brazing material is formed of an aluminum alloy comprising 5.00 mass % to 13.00 mass % of Si, and
the intermediate layer is formed of an aluminum alloy having a Mg content of 0.20 mass % or less.

23. The aluminum alloy brazing sheet according to claim 21, comprising:
the multilayer including a four-layer material comprising an intermediate layer and a brazing material cladded on one side surface of the core material and a sacrificial anode material cladded on the other side surface of the core material in order of brazing material/intermediate material/core material/sacrificial anode material, wherein
the brazing material is formed of an aluminum alloy comprising 5.00 mass % to 13.00 mass % of Si,
the intermediate layer is formed of an aluminum alloy having a Mg content of 0.20 mass % or less, and
the sacrificial anode material is formed of an aluminum alloy comprising 0.50 mass % to 3.00 mass % of Zn.

24. The aluminum alloy brazing sheet according to claim 21, comprising:
the multilayer including a five-layer material comprising an intermediate layer and a brazing material cladded on one side surface of the core material and an intermediate layer and a brazing material cladded on the other side surface of the core material in order of brazing material/intermediate material/core material/intermediate layer/brazing material, wherein
the brazing material is formed of an aluminum alloy comprising 5.00 mass % to 13.00 mass % of Si, and
the intermediate layer is formed of an aluminum alloy having a Mg content of 0.20 mass % or less.

25. An aluminum alloy brazing sheet for an aluminum alloy heat exchanger, the aluminum alloy brazing sheet including a multilayer comprising:
a core material of the aluminum alloy brazing sheet formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities, in which the following any one of (b1) to (b5) is satisfied:
(b1) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to a low retention temperature at an average temperature falling rate of 20° C./min to 120° C./min, and thereafter retained at 150±5° C. for 60±5 minutes, a Vickers hardness of a core material part cross-section of the aluminum alloy brazing sheet after the heating and high temperature retention test is 66 or more,
(b2) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to a low retention temperature at an average temperature falling rate of 20° C./min to 120° C./min, and thereafter retained at 170±5° C. for 40±5 minutes, a Vickers hardness of a core material part cross-section of the aluminum alloy brazing sheet after the heating and high temperature retention test is 66 or more,
(b3) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to a low retention temperature at an average temperature falling rate of 20° C./min to 120° C./min, and thereafter retained at 190±5° C. for 5±2 minutes, a Vickers hardness of a core material part cross-section of the aluminum alloy brazing sheet after the heating and high temperature retention test is 66 or more,
(b4) in a heating and high temperature retention test in which a temperature is raised to a heating retention temperature at an average temperature rising rate of 10° C./min to 100° C./min, retained at 600±10° C. for 3±2 minutes, subsequently dropped from the heating retention temperature to a low retention temperature at an average temperature falling rate of 20° C./min to 120° C./min, and thereafter retained at 210±5° C. for 5±2 minutes, a Vickers hardness of a core material part cross-section of the aluminum alloy brazing sheet after the heating and high temperature retention test is 66 or more, and (b5) in a heating and low temperature retention test in which a temperature is raised to a heating retention temperature at an average temperature rising rate of 50° C./min to 150° C./min, retained for 3±2 minutes at 600±10° C., subsequently dropped from the heating retention temperature to a low retention temperature at an average temperature falling rate of 20° C./min to 120° C./min, and thereafter retained for 336±5 hours at 25±5° C., a Vickers hardness of a core material part cross-section of the aluminum alloy brazing sheet after the heating and low temperature retention test is 66 or more.

26. The aluminum alloy brazing sheet according to claim 25, comprising:
the multilayer including a three-layer material comprising an intermediate layer and a brazing material clad on one side surface of the core material in order of brazing material/intermediate material/core material, wherein
the brazing material is formed of an aluminum alloy comprising 5.00 mass % to 13.00 mass % of Si, and
the intermediate layer is formed of an aluminum alloy having a Mg content of 0.20 mass % or less.

27. The aluminum alloy brazing sheet according to claim 25, comprising:
the multilayer including a four-layer material comprising an intermediate layer and a brazing material cladded on one side surface of the core material and a sacrificial anode material cladded on the other side surface of the core material in order of brazing material/intermediate material/core material/sacrificial anode material, wherein
the brazing material is formed of an aluminum alloy comprising 5.00 mass % to 13.00 mass % of Si,
the intermediate layer is formed of an aluminum alloy having a Mg content of 0.20 mass % or less, and
the sacrificial anode material is formed of an aluminum alloy comprising 0.50 mass % to 3.00 mass % of Zn.

28. The aluminum alloy brazing sheet according to claim 25, comprising:
the multilayer including a five-layer material comprising an intermediate layer and a brazing material cladded on one side surface of the core material and an intermediate layer and a brazing material cladded on the other side surface of the core material in order of brazing material/intermediate material/core material/intermediate layer/brazing material, wherein
the brazing material is formed of an aluminum alloy comprising 5.00 mass % to 13.00 mass % of Si, and
the intermediate layer is formed of an aluminum alloy having a Mg content of 0.20 mass % or less.

29. A method for producing an aluminum alloy brazing sheet including a multilayer for an aluminum alloy heat exchanger, the method comprising:
a casting step of casting an ingot for a core material formed of an aluminum alloy comprising 0.20 mass % to 1.00 mass % of Si, 0.10 mass % to 0.80 mass % of Mn, and 0.20 mass % to 1.00 mass % of Mg, having a value of “Mn content (mass %)/Si content (mass %)” of 0.10 or more and less than 1.00, a value of “Mg content (mass %)+Si content (mass %)” of 0.60 mass % or more and less than 1.60 mass %, a Fe content of 0.40 mass % or less, a Cu content of 0.25 mass % or less, a Cr content of 0.10 mass % or less, a Zn content of 2.00 mass % or less, a Ti content of 0.10 mass % or less, and a Zr content of 0.10 mass % or less, with the balance being Al and inevitable impurities;
a homogenization treatment step of heating the ingot for a core material at 400° C. to 540° C.;
a hot rolling step of stacking a hot-rolled ingot for a clad material onto the ingot for a core material to perform hot rolling; and
a cold rolling step.

30. The method for producing an aluminum alloy brazing sheet according to claim 29, wherein final annealing treatment of heating at 350° C. or more is performed after performing the cold rolling step.

31. The method for producing an aluminum alloy brazing sheet according to claim 29, wherein final annealing treatment of heating at less than 350° C. is performed after performing the cold rolling step.

32. The method for producing an aluminum alloy brazing sheet according to claim 29, wherein intermediate annealing treatment of heating at 350° C. or more is performed in the course of the cold rolling step.
